(19) United States
(12) Patent Application Publication
(10) Pub. No.: US 2014/0347353 A1
(43) Pub. Date: Nov. 27, 2014

(54) OVERLAY AND MOTION COMPENSATION OF STRUCTURES FROM VOLUMETRIC MODALITIES ONTO VIDEO OF AN UNCALIBRATED ENDOSCOPE

(71) Applicant: KONINKLIJKE PHILIPS N.V., EINDHOVEN (NL)

(72) Inventors: Aleksandra Popovic, New York, NY (US); Haytham Elhawary, New York, NY (US)

(21) Appl. No.: 14/363,840

(22) PCT Filed: Dec. 17, 2012
(86) PCT No.: PCT/IB2012/057393

§ 371 Date: Jun. 9, 2014

Related U.S. Application Data
(60) Provisional application No. 61/578,427, filed on Dec. 21, 2011.

(51) Int. Cl. G06T 11/60; G06T 11/00

(52) U.S. Cl. CPC G06T 11/60; G06T 11/006; G06T 2210/41; G06T 2200/32
USPC 345/419

(57) ABSTRACT

A method, system, and program product are provided for overlaying structures from volumetric modalities onto video of an uncalibrated endoscope. The method comprises: determining correspondence (310) of a plurality of point pairs between a structure on a 3D preoperative image and the structure on a 2D endoscope video image; deriving a projection matrix for translation (320) from the 3D image to the 2D image using assumed camera parameters and the corresponding point pairs; rendering a 2D projection (330) of the structure from the 3D image onto the 2D endoscope image using the derived projection matrix; determining a homography matrix; and warping the rendered structure projection (340), using the homography matrix.

### CROSS-REFERENCE TO RELATED APPLICATION

This application is related to provisional patent application No. 61/382,980, “Robotic Control of an Endoscope from Blood Vessel Tree Images,” filed Sep. 15, 2010 and co-pending nonprovisional international application PCT/IB2011/053998, filed Sep. 13, 2011, which are incorporated herein by reference.

### FIELD OF THE INVENTION

The invention relates to the field of medical imaging and more particularly to a method, system and computer program product for overlaying three-dimensional structures from volumetric imaging modalities onto video of an uncalibrated endoscope and compensating motion of the volumetric structures on the video of the endoscope.

### BACKGROUND

In minimally invasive coronary bypass surgery, two imaging modalities are typically used: (1) preoperative 3D imaging (such as Computerized Tomography, or CT or 3D X-ray angiography) to extract information about geometry of coronary arteries, and (2) real-time endoscopic imaging. Coronary arteries are usually not completely visible on endoscope video due to different tissue covering them. Also, endoscope video is typically recorded in two dimensions. Volumetric 3D images provide a complete visualization of coronary arteries in three dimensions. However, a surgeon must accurately visualize the location of the coronary arteries in endoscope video to successfully perform minimally invasive coronary bypass surgery. To determine the location of the arteries where they are not visible on endoscope video, the arteries can be overlaid onto the endoscope video.

However, existing methods for overlaying pre-operative 3D imaging data, such as from a CT scan onto an endoscopic video require calibration of the endoscope, tracking with an additional localization system, or both. Calibrating an endoscope is a complex procedure, prone to errors if not properly done, and therefore not very practical in clinical environments. Optical properties of an endoscope may change with utilization, so one time calibration cannot be used over long periods of time. In addition, localization systems, such as optical markers, are not always available during surgery and add considerable cost and time to the procedure.

Moreover, three-dimensional imaging for planning in cardiac and other surgeries is not usually performed in time series (such as gated CT). Thus, the 3D geometry of structures does not take into account movement due to physiological processes such as the heartbeat and breathing. For example, in cardiac surgery, arterial tree geometry is known for only one phase of the cardiac cycle.

### SUMMARY

A method, system and program product are provided for overlaying structures from volumetric modalities onto video of an uncalibrated endoscope. The method comprises: determining correspondence of a plurality of point pairs between a structure on a 3D preoperative image and the structure on a 2D endoscope video image; deriving a projection matrix for translation from the 3D image to the 2D image using assumed camera parameters and the corresponding point pairs; rendering a 2D projection of the structure from the 3D image onto the 2D endoscope image using the derived projection matrix; determining a homography matrix; and warping the rendered structure projection, using the homography matrix.

According to one embodiment, the structure is an arterial tree and the plurality of point pairs are bifurcations of the arterial tree.

According to one embodiment, the structure is a venous tree and the plurality of point pairs are bifurcations of the venous tree.

According to one embodiment, the structure is a bronchial tree and the plurality of point pairs are bifurcations of the bronchial tree.

According to one embodiment, correspondence of a plurality of point pairs is determined by matching a pattern of furcations in a tree structure in the 2D endoscope image with a corresponding pattern of furcations in the tree structure from the 3D image.

According to one embodiment, the homography matrix is derived using the determined point pairs.

According to one embodiment, a homography matrix is derived for each of more than one different subsections of the 2D endoscope image.

According to one embodiment, motion compensation is provided for the overlaid structure. A correspondence matrix is derived by transforming points from a frame of the endoscope image to any subsequent frame of the endoscope image. Then the rendered structure projection is warped using the correspondence matrix to track motion of the structure.

According to one embodiment, a plurality of correspondence matrices calculated over time series are used to warp the overlaid structure.

According to another aspect of the present invention, a method is provided to compensate for motion in an overlaid structure. The method for motion compensation of a structure overlay rendered from a volumetric modality on video of an uncalibrated endoscope comprises the steps of: determining a correspondence matrix for transforming points from a frame of the endoscope image to any subsequent frame of the endoscope image; and warping the rendered overlay structure, using the correspondence matrix to track motion of the structure.

According to another aspect of the present invention, a system is provided for overlaying structures from volumetric modalities onto video of an uncalibrated endoscope. The system comprises: a processor; a memory operably associated with the processor; a display operably associated with the processor; and an overlay program of instruction encoded on the memory and executed by the processor to: determine correspondence of a plurality of point pairs between a structure on a 3D preoperative image and the structure on a 2D endoscope video image; derive a projection matrix for translation from the 3D image to the 2D image using assumed camera parameters and the corresponding point pairs; render a 2D projection of the structure from the 3D image onto the 2D endoscope image using the derived projection matrix; determine a homography matrix; and warp the rendered structure projection, using the homography matrix.

According to one embodiment, the overlay program of instructions derives a homography matrix for each of more than one different subsections of the 2D endoscope image.

According to one embodiment, the overlay program of instruction when executed by the processor also provides motion compensation for the overlaid structure. To provide motion compensation, the overlay program of instruction determines a correspondence matrix for transforming points from a first frame of the endoscope image to a second frame of the endoscope image, and warps the rendered structure projection, using the correspondence matrix to track motion of the overlaid structure.

According to another aspect of the present invention, a computer program product is provided for overlaying structures from volumetric modalities onto video of an uncalibrated endoscope. The computer program product comprises a computer-readable storage device having encoded thereon a computer-executable program of instructions, comprising: computer-executable instructions for determining correspondence of a plurality of point pairs between a structure on a 3D preoperative image and the structure on a 2D endoscope video image; computer-executable instructions for deriving a projection matrix for translation from the 3D image to the 2D image using assumed camera parameters and the corresponding point pairs; computer-executable instructions for rendering a 2D projection of the structure from the 3D image onto the 2D endoscope image using the derived projection matrix; computer-executable instructions for determining a homography matrix; and computer-executable instructions for warping the rendered structure projection, using the homography matrix.

According to one embodiment, the computer-executable program of instructions further comprises: computer-executable instructions for determining a correspondence matrix for transforming points from a first frame of the endoscope image to a second frame of the endoscope image; and computer-executable instructions for warping the rendered structure projection, using the correspondence matrix to track motion of the structure.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a system for overlaying structures from volumetric modalities onto video of an uncalibrated endoscope according to an embodiment of the present invention;

FIG. 2 is a flow diagram of a method for overlaying structures from volumetric modalities onto video of an uncalibrated endoscope according to an embodiment of the present invention;

FIG. 3 is an endoscope image during a cardiac procedure showing visible arterial structure;

FIG. 4 is a flow diagram of a method for matching corresponding point pairs in a 3D image and a 2D image according to an embodiment of the present invention;

FIG. 5 is an endoscope image during a cardiac procedure with an arterial tree structure overlaid on it prior to warping with an homography matrix according to an embodiment of the present invention;

FIG. 6 is flow diagram of a method for motion compensation of an overlay on a 2D endoscope image according to an embodiment of the present invention;

FIG. 7 is an endoscope image during a cardiac procedure showing selection of tracking features according to an embodiment of the present invention; and

FIG. 8 is an endoscope image at a subsequent frame from FIG. 5, showing movement of the selected features.

### DETAILED DESCRIPTION

The present invention provides a method, system, and computer program product for overlaying structures from volumetric modalities onto video of an uncalibrated endoscope. According to one embodiment of the present invention, correspondence of a plurality of point pairs is determined between a structure on a 3D preoperative image and the structure on a 2D endoscope video image. A projection matrix for transformation from the 3D image to the 2D image is derived using estimated camera parameters and the corresponding point pairs. The endoscope is not calibrated. In particular, that means that the camera parameters, such as focal lengths and center of the optical image are not known. The estimated camera parameters thus are estimated without knowing exact parameters. A 2D projection of the structure is rendered from the 3D image onto the 2D endoscope image using the derived projection matrix. A homography matrix is determined for the endoscope image and 2D projection of the structure, and the rendered structure projection is warped using the homography matrix.

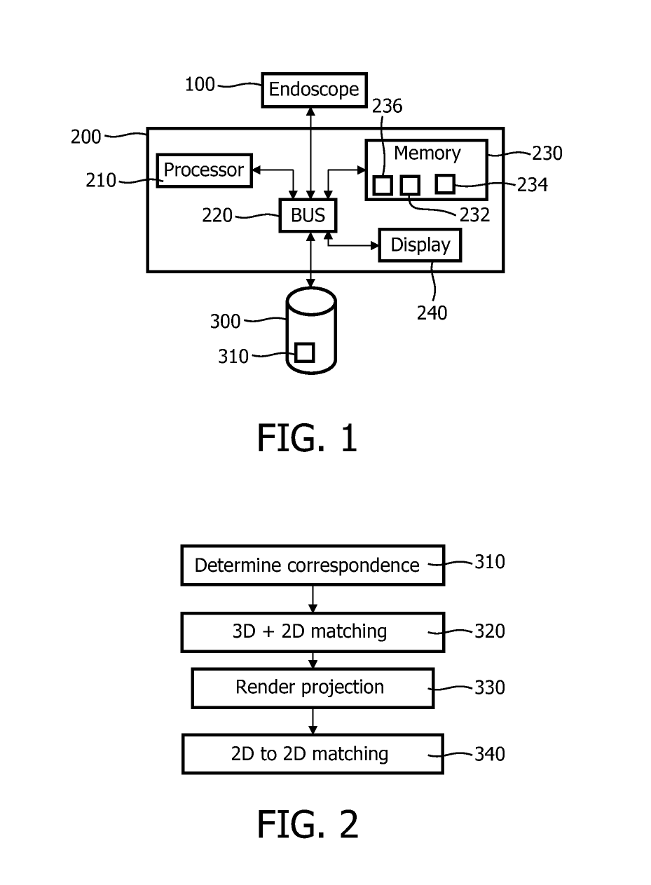

FIG. 1 is a block diagram of a system for overlaying structures from volumetric modalities onto video of an uncalibrated endoscope according to an embodiment of the present invention. The system comprises: an endoscope 100 and a processing system 200. The endoscope 100 may be any endoscope suitable for providing images during a minimally invasive surgical procedure. Moreover, the endoscope 100 may comprise more than one endoscope used together or in series.

The processing system 200 may be any system suitable for processing and displaying medical images, such as a general purpose computer. The processing system 200 comprises a processor 210 operably connected to a memory 230, such as through a system bus 220. It should be understood that other suitable architectures are also possible within the scope of the present invention. The processor 210 may be any suitable processor, such as one or more microprocessors. The memory 230 may be any suitable memory, including but not limited to: RAM, ROM, an internal hard drive, a disk drive, a USB flash drive, or any other memory device suitable for storing program code. The memory 230 has encoded on it an endoscope video program of instruction 232 executed by the processor 210 to process and display an endoscope video image in real time. The memory also has encoded thereon, either as a part of or callable by the endoscope program of instruction, an overlay program of instruction 234 for overlaying structures from volumetric modalities onto the video images from the endoscope. Also encoded on the memory 230 is a blood vessel tree extractor 236 which is operable by the overlay program of instruction 234 to extract a geometric representation of a arterial tree structure.

The video images from the endoscope 100 are presented on a display 240 for viewing by a surgeon during a surgical procedure.

Structure data 301 for an anatomical structure, such as an arterial tree is retrieved from a data storage device 300. The structure data 301 may be in the form of an extracted geometric representation of the structure. In practice, a Brilliance iCT scanner sold by Philips may be used to generate an image and extract a representation of a structure, such as an arterial tree.

The program of instruction 234 executed by the processor 210: determines correspondence of a plurality of point pairs between a structure on a 3D preoperative image and the structure on a 2D endoscope video image, derives a projection matrix for translation from the 3D image to the 2D image using assumed camera parameters and the corresponding point pairs; renders a 2D projection of the structure from the 3D image onto the 2D endoscope image using the derived projection matrix, determines a homography matrix, and warps the rendered structure projection, using the homography matrix.

FIG. 2 is a flow diagram of a method for overlaying structures from volumetric modalities onto video of an uncalibrated endoscope according to an embodiment of the present invention. The overlay program of instruction 234 determines correspondence of a plurality of point pairs between a structure on a 3D preoperative image and the structure on a 2D endoscope video image (Step 310). The following description will describe detecting corresponding point pairs on a coronary arterial structure. However, the structure may be any arterial tree, a veinous tree, a bronchial tree, or any other anatomical structure with a pattern of distinguishable features such as furcations.

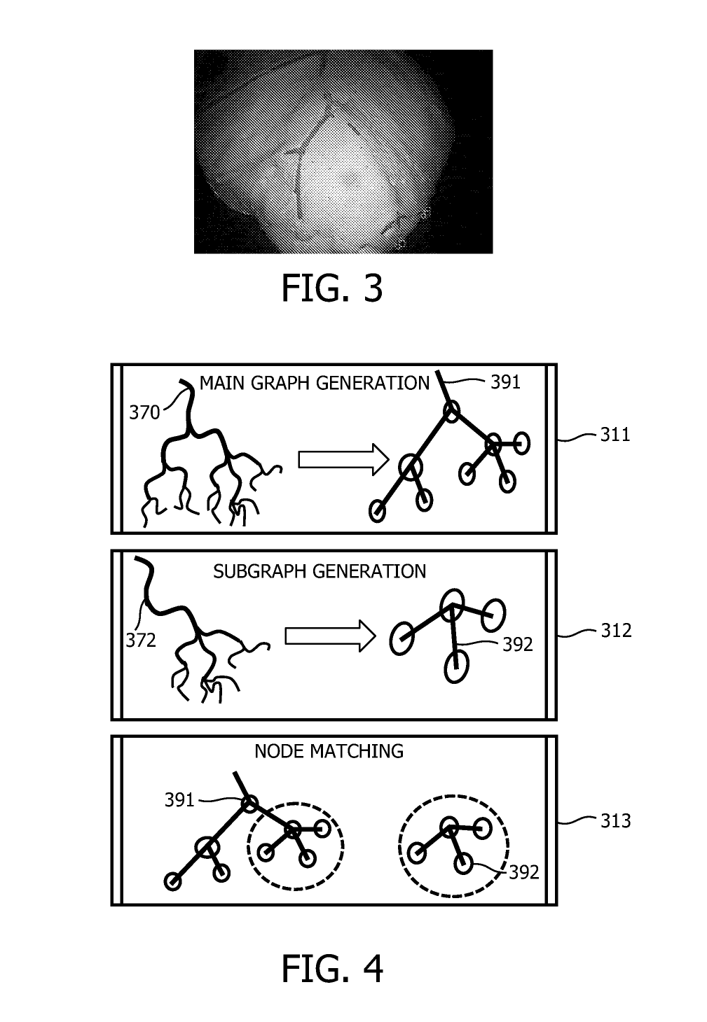

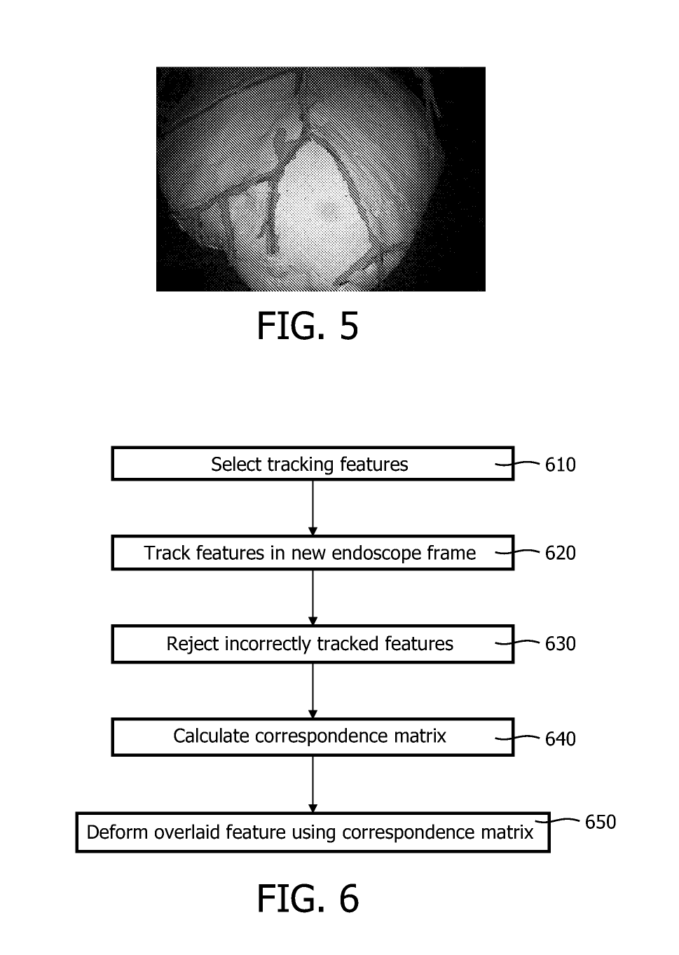

In practice, as shown in FIG. 3, some portions of an arterial structure may be visible on the endoscope video images, while other portions of the arterial structure are hidden by a layer of fatty tissue. As shown in FIG. 4, the overlay program of instruction 234 may implement an automatic detection of visible coronary arteries by known image processing operations, such as threshold detection of visible portions 372 of the coronary arteries. Alternatively, a surgeon may manually input arterial structures by using an input device, such as a mouse that interacts with the video display 240.

A blood vessel tree extractor 236, which is known in the art, is operated by the overlay program of instruction 234 to extract a geometrical representation (subgraph) 392 of the visible portion 372 of coronary artery structure (Step 312). The geometric representation comprises nodes representing each furcation of the arterial structure and having branch connections between the nodes.

The overlay program of instruction 234 also receives a geometric representation (main graph) 391 of the complete coronary arterial tree extracted from the complete coronary artery structure 370 by a 3D imaging system during a preoperative scan (step 311). Because the visible portion of the coronary artery structure in the endoscope image comes from the same patient as the representation of the complete coronary arterial tree from the 3D scan, it is a subgraph of the extracted 3D tree representation.

The overlay program of instruction 234 matches the subgraph 392 to the main graph 391 using any suitable graph matching method, such as the maximum common subgraph method, the McGregor common subgraph method, or the like (Step 313). For example the nodes of the subgraph 392 are matched a subset of nodes from the main graph 391. Now, the surrounding arterial tree that is not visible is known from the 3D imaging.

The overlay program of instruction 234 derives a projection matrix for transformation from the 3D structure to the 2D image using assumed camera parameters and the corresponding point pairs (Step 320). The 3D coordinates and the 2D coordinates of the matched nodes (or furcations) are entered into a formula together with assumed values for the focal length and optical center of the endoscope to solve for a projection matrix for projecting the shape of the arteries from the 3D image onto the 2D endoscope image. Computation of the 3×4 projection matrix P is known in art as resectioning. For paired correspondences of N 3D structure points Xi=[Xi, Yi, Zi]^{T} and N 2D image points xi=[xi, yi, zi]^{T}, the following formula can be used to compute projection matrix P=[P1^{T} P2^{T} P3_{T}].

$$[ \begin{matrix}{0}^{T} & - {X}_{i}^{T} & {y}_{i} {X}_{i}^{T} \\ {X}_{i}^{T} & {0}^{T} & - {x}_{i} {X}_{i}^{T} \\ - {y}_{i} {X}_{i}^{T} & {x}_{i} {X}_{i}^{T} & {0}^{T}\end{matrix} ] [ \begin{matrix}{P}_{1} \\ {P}_{2} \\ {P}_{3}\end{matrix} ] = 0. \qquad ( Eq . 1 )$$

From a set of N point correspondences, we obtain a 2×12 matrix A by stacking up the equations for each correspondence. The projection matrix P is computed by solving the set of equations Ap=0, where p is the vector containing the entries of the matrix P. Numerical solution of the equations can be done using Direct Linear transformation. The projection matrix comprises three translation dimensions and three angles of rotation which define the endoscope location and orientation.

In order to assure that all features of interest are visible, the assumed focal length should be greater than any possible focal length for any endoscope to be used.

After the projection matrix is derived, the overlay program of instruction 234 renders a 2D projection of the structure from the 3D image onto the 2D endoscope image using the derived projection matrix (Step 330). The coordinates for each voxel of the 3D structure are multiplied with the projection matrix, and the product is overlaid onto the 2D endoscope image. Due to the assumed values for the focal length and optical center of the endoscope, the projected structures will not be particularly accurate. The projected features will not be to the correct scale due to the estimated focal length, and will not be accurately located due to the assumed optical center.

The overlay program of instruction 234 then performs a 2D to 2D matching (Step 340). This may be accomplished by determining a homography matrix and warping the rendered structure projection, using the homography matrix. To determine the homography matrix, the overlay program of instruction 234 again uses the matched point pairs. This time, the coordinates for matched points or nodes on the 2D projection and the coordinates for the matched points or nodes from the endoscope image are used to interatively derive a 3×3 homography matrix.

Then, each pixel of the 2D projection is multiplied with the homography matrix to warp the projected structure to the scale and position of the endoscope image. According to one embodiment an alpha channel can be added to allow overlay without occluding underlying structures.

According to one embodiment, homography matrices are derived for each of more than one subsection of the endoscope image, and portions of the overlaid structure in each subsection are warped separately using the corresponding homography matrix. This provides a more accurate overlay when the postioning of features in the endoscope image is different from the positioning in the 3D image, such as movement due to the cardiac cycle, breathing, deflation of a lung for a surgical procedure, and the like.

The forgoing overlay process can be repeated each time an overlay of a structure is desired. Alternatively, an accurate camera matrix can be calculated by multiplying the calculated projection matrix and the calculated homography matrix. Once an accurate camera matrix is calculated an overlay can be performed accurately each time without recalculating the projection and homography matrices.

Movement of the structure due to the cardiac cycle, breathing, or the like as well as movement of the endoscope may also be tracked and compensated for as a structure. This compensation can be performed once the projection and homography matrices have been determined and the structure overlaid onto the endoscope image.

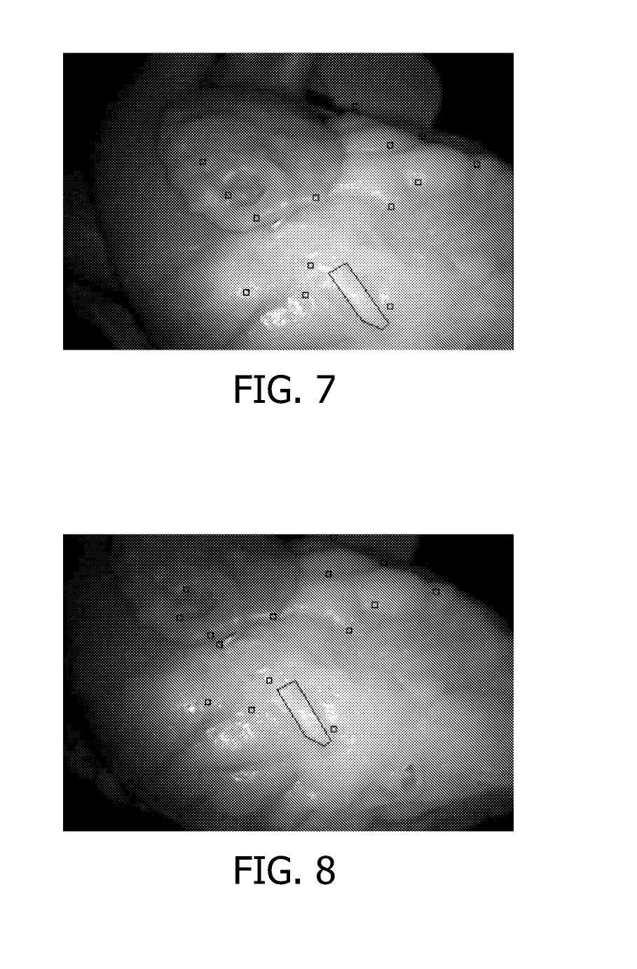

FIG. 6 is a flow diagram of a method for motion compensation of an overlay on a 2D endoscope image according to an embodiment of the present invention. As shown in FIG. 7, the overlay program of instruction 234 receives a selection of features 1-13 on the endoscope image to be tracked (Step 610). These features can be selected manually, such as with an input device like a mouse, which a surgeon can use to indicate features to be tracked on a display. Alternatively, the overlay program of instruction may include or call a selection algorithm that selects features which have mathematical properties that make them easier to track, such as the SURF descriptor, for example. The selected features may be features on the overlaid structure (e.g., furcations of an arterial structure), features on a moving structure (e.g., edges of fat on the heart), or a combination thereof

The selected features 1-13 are then tracked in successive frames of the endoscope video (Step 620), as shown in FIG. 8. The selected features may be tracked using techniques known in the art, such as the Lucas-Kanade tracking algorithm with pyramidal implementation. The result of the tracking step is a set of features in the previous frame, and the corresponding position of those features in the current frame.

Optionally, the overlay program of instruction 234 may include or call a filter to identify and reject incorrectly tracked features (Step 630). If any feature has not been correctly tracked, then it is desirable, but not necessary to reject the incorrectly tracked feature. Failed tracking means that the feature, at its new position in the second frame, is not correctly detected. Failed tracking may be detected, for example, by a lack of convergence if an iterative method, such as the Lucas-Kanade algorithm is used to determine the latest position of a feature. The positions of features determined not to be correctly tracked are ignored in the present frame, and only the remaining feature positions are used for determining position and shape of the overlay.

Using the corresponding positions of tracked features in consecutive frames, the overlay program of instruction 234 calculates a 3×3 correspondence matrix which can transform the features from their positions on the first frame to their positions on the second frame (Step 640). Mathematical methods for the calculation of transform matrices using corresponding point locations is well known in the art. For three points, affine transformation is computed. If more than three points are used, a homography matrix can be computed.

Alternatively, a plurality of correspondence matrices may be calculated for different subareas of the endoscope image. Using multiple correspondence matrices may lead to a finer prediction and more accurate overlay. However, there is a computational cost for using multiple correspondence matrices.

Once the correspondence matrix or matrices have been computed, they can be used to piecewise deform the volumetric overlay (Step 650). The deformed overlay adapts the position of the overlaid structure to compensate for the new position in the present frame due to motion. If multiple correspondence matrices are used, the deformed overlay also compensates for the change in shape of the structure due to motion, such as the deformation of an arterial structure by the beating heart.

The invention can take the form of an entirely hardware embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable storage medium providing program code for use by or in connection with a computer or any instruction execution system or device. For the purposes of this description, a computer-usable or computer readable storage medium may be any apparatus that can contain or store the program for use by or in connection with the instruction execution system, apparatus, or device.

The foregoing method may be realized by a program product comprising a machine-readable medium having a machine-executable program of instructions, which when executed by a machine, such as a computer, performs the steps of the method. This program product may be stored on any of a variety of known machine-readable medium, including but not limited to compact discs, floppy discs, USB memory devices, and the like.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

1. A method for overlaying structures from volumetric modalities onto video of an uncalibrated endoscope, comprising the steps of:
determining correspondence of a plurality of point pairs between a structure on a 3D preoperative image and the structure on a 2D endoscope video image;
deriving a projection matrix for translation from the 3D image to the 2D image using assumed camera parameters and the corresponding point pairs;
rendering a 2D projection of the structure from the 3D image onto the 2D endoscope image using the derived projection matrix;
determining a homography matrix; and
warping the rendered structure projection, using the homography matrix.

2. The method of claim 1 wherein the structure is an arterial tree and the plurality of point pairs are bifurcations of the arterial tree.

3. The method of claim 1 wherein the structure is a venous tree and the plurality of point pairs are bifurcations of the venous tree.

4. The method of claim 1 wherein the structure is a bronchial tree and the plurality of point pairs are bifurcations of the bronchial tree.

5. The method of claim 1, wherein correspondence of a plurality of point pairs is determined by matching a pattern of furcations in a tree structure in the 2D endoscope image with a corresponding pattern of furcations in the tree structure from the 3D image.

6. The method of claim 1, wherein the homography matrix is derived using the determined point pairs.

7. The method of claim 1, wherein a homography matrix is derived for each of more than one different subsections of the 2D endoscope image.

8. (canceled)

9. (canceled)

10. (canceled)

11. A system for overlaying structures from volumetric modalities onto video of an uncalibrated endoscope, comprising:
a processor;
a memory operably associated with the processor;
a display operably associated with the processor; and
an overlay program of instruction encoded on the memory and executed by the processor to:
determine correspondence of a plurality of point pairs between a structure on a 3D preoperative image and the structure on a 2D endoscope video image;
derive a projection matrix for translation from the 3D image to the 2D image using assumed camera parameters and the corresponding point pairs;
render a 2D projection of the structure from the 3D image onto the 2D endoscope image using the derived projection matrix;
determine a homography matrix; and
warp the rendered structure projection, using the homography matrix.

12. The system of claim 11, wherein the overlay program of instructions derives a homography matrix for each of more than one different subsections of the 2D endoscope image.

13. (canceled)

14. (canceled)

15. A computer program product for overlaying structures from volumetric modalities onto video of an uncalibrated endoscope, the computer program product comprising a computer-readable storage device having encoded thereon a computer-executable program of instructions, comprising:
computer-executable instructions for determining correspondence of a plurality of point pairs between a structure on a 3D preoperative image and the structure on a 2D endoscope video image;
computer-executable instructions for deriving a projection matrix for translation from the 3D image to the 2D image using assumed camera parameters and the corresponding point pairs;
computer-executable instructions for rendering a 2D projection of the structure from the 3D image onto the 2D endoscope image using the derived projection matrix;
computer-executable instructions for determining a homography matrix; and
computer-executable instructions for warping the rendered structure projection, using the homography matrix.

16. The computer program product of claim 15, wherein a homography matrix is derived for each of more than one different subsections of the 2D endoscope image.

17. (canceled)

18. (canceled)

19. The method of claim 1, wherein the assumed focal length is greater than any possible focal length for the endoscope.

20. The method of claim 1, wherein further comprising the step of calculating an accurate camera matrix by multiplying the derived projection matrix and the determined homography matrix.
